(19) United States
(12) Patent Application Publication
(10) Pub. No.: US 2010/0261825 A1
(43) Pub. Date: Oct. 14, 2010

(54) COATING COMPOSITIONS COMPRISING POLYUREA AND AN ANTI-OXIDANT COMPOUND

(76) Inventors: Howard L. Senkfor, South Euclid, OH (US); Steven V. Barancyk, Wexford, PA (US); Rickie A. Brown, Cleveland, OH (US); John M. Furar, Pittsburgh, PA (US); Thomas R. Hockswender, Gibsonia, PA (US); Debra L. Singer, Wexford, PA (US); James F. Stewart, Sheffield Lake, OH (US)

Correspondence Address: PPG INDUSTRIES INC;INTELLECTUAL PROPERTY DEPT, ONE PPG PLACE, PITTSBURGH, PA, 15272, US

(21) Appl. No.: 12/759,106

(22) Filed: Apr. 13, 2010

Related U.S. Application Data
(60) Provisional application No. 61/168,761, filed on Apr. 13, 2009.

(51) Int. Cl. C09D 175/02

(52) U.S. Cl. 524/323; 524/445; 524/500; 524/589

(57) ABSTRACT

The present invention is directed to a coating composition comprising polyurea formed from a reaction mixture comprising: (a) a first component comprising isocyanate and (b) a second component comprising an amine; and wherein the reaction mixture comprises an anti-oxidant compound a hindered amine light stabilizing compound, or combinations thereof.

### CROSS-REFERENCE TO RELATED APPLICATIONS

This application claims benefit of U.S. Provisional Application No. 61/168,761 filed Apr. 13, 2009.

### FIELD OF THE INVENTION

The present invention is directed to a coating composition comprising polyurea and an anti-oxidant compound.

### BACKGROUND

Coating compositions are used in a wide variety of industries. Such industries may include landcraft, watercraft, aircraft, industrial, construction, as well as the military. In these industries, coatings serve a variety of purposes such as protecting various components against damage due to corrosion, abrasion, impact, chemicals, ultraviolet light, flame and heat, and other environmental exposure as well as imparting ballistic and blast mitigation properties to the components onto which they are deposited. Accordingly, considerable efforts have been expended to develop coating compositions with improved properties.

### SUMMARY OF THE INVENTION

The present invention is directed to a coating composition comprising polyurea formed from a reaction mixture comprising: (a) a first component comprising isocyanate and (b) a second component comprising an amine; and wherein the reaction mixture further comprises an anti-oxidant compound, hindered amine light stabilizing compound, or combinations thereof; and wherein the anti-oxidant compound, hindered amine light stabilizing compound, or combinations thereof comprises 1 weight % to 20 weight % of the total resin solids of the coating composition.

The present invention is a coating composition comprising polyurea formed from a reaction mixture comprising: (a) a first component comprising isocyanate, wherein the first component comprises an isocyanate functional prepolymer formed from a reaction mixture comprising an isocyanate and a material comprising a phosphorus-containing polyol; (b) a second component comprising an amine; and wherein the reaction mixture comprises an anti-oxidant compound a hindered amine light stabilizing compound, or combinations thereof.

### DETAILED DESCRIPTION OF THE INVENTION

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges contained therein. Plural encompasses singular and vice versa. “Including” and like terms are open ended; that is, they mean “including but not limited to”. For example, while the invention has been described herein including the claims in terms of “an” anti-oxidant compound, “a” polyurea, “a” polyurethane, “an” isocyanate, “an” amine, “a” polyol, “a” prepolymer, “a” hindered amine light stabilizing compound, and the like, mixtures of all of such things can be used. Also, as used herein, the term “polymer” is meant to refer to prepolymers, oligomers and both homopolymers and copolymers; the prefix “poly” refers to two or more.

### Coating Composition

The present invention is directed to a coating composition comprising polyurea formed from a reaction mixture comprising a first component comprising an isocyanate (“isocyanate component”), and a second component comprising an amine (“amine component”); and optionally polyurethane. The reaction mixture disclosed herein comprises an anti-oxidant compound a hindered amine light stabilizing compound, or combinations thereof. Suitable anti-oxidants that may be used in the present invention include phenolic and/or phosphorus based anti-oxidants. Suitable examples of such anti-oxidants include ANNOX IC-14 (available from Chemtura Corp.) as well as those described in Table 1 of U.S. Patent Pub. No. 2007/0203269, which Table 1 is incorporated by reference in its entirety herein. Suitable hindered amine light stabilizing compounds that may be used in the present invention include polymeric hindered amine light stabilizing compounds, monomeric hindered amine light stabilizing compounds, or combinations thereof. Suitable polymeric hindered amine light stabilizing compounds include TINUVIN 266, CHIMASORB 199FL, CHIMASORB 944 FDL, TINUVIN 622 (all of which are available from Ciba), CYASORB UV3529, CYASORB UV 3346 (both of which are available from Cytec Industries), polymers with hindered amine light stabilizing functionality, or combinations thereof. Suitable monomeric hindered amine light stabilizing compounds that may be used in the present invention include CYASORB UV3853 (available from Cytec).

The coating composition of the present invention can exhibit improved flame and/or heat resistance when compared to similar coating compositions that do not comprise the anti-oxidant compound and/or hindered amine light stabilizing compound disclosed herein. As used herein, the term “flame retardant”, “flame resistant”, and the like refers to the ability of a substance to reduce a material's tendency to support propagation of combustion, burning, fire, flame and/or to reduce the likelihood of ignition and/or to reduce the heat generated by the combusting and/or burning of the material. As used herein, the terms “improved flame resistance” means any degree of improved flame resistance, respectively that is demonstrated by a coating composition with flame retardant material as compared to a coating composition without flame retardant material.

As used herein, the coating composition that is derived from the reaction mixture described herein is not a thermoplastic material, but rather a thermosetting material. Accordingly, “coating composition” does not include materials, such as plastics that are manufactured from polyvinylchloride.

The anti-oxidant and/or the hindered amine light stabilizing compounds may be added to one or both of the isocyanate or amine components using techniques known in the art. By way of example, in certain embodiments, the anti-oxidant and/or amine light stabilizing compound is added directly into the isocyanate component of the reaction mixture prior to the isocyanate component being introduced to the amine component. In other embodiments, the anti-oxidant and/or amine light stabilizing compound is added directly into the amine component prior to the amine component being introduced to the isocyanate component. In some embodiments, the isocyanate component may comprise an anti-oxidant compound while the amine component comprises a polymeric hindered amine light stabilizing compound.

In certain embodiments, the anti-oxidant and/or the hindered amine light stabilizing compound comprises ≧1 weight % of the total resin solids of the reaction mixture. In other embodiments, the anti-oxidant and/or the hindered amine light stabilizing compound comprises ≦20 weight % of the total resin solids of the reaction mixture. In certain embodiments, the total amount of anti-oxidant and/or the hindered amine light stabilizing compound can range between any combination of values, which were recited in the preceding sentences, inclusive of the recited values. For example, in some embodiments, the total amount of anti-oxidant and/or hindered amine light stabilizing compound can range from 5 weight % to 15 weight %, such as from 5 weight % to 8 weight % or from 10 weight % to 12 weight %, based on the total resin solids of the reaction mixture.

In some embodiments, the total amount of anti-oxidant and/or the hindered amine light stabilizing compound comprises ≧10 weight % of the total resin solids of the amine component. In other embodiments, the anti-oxidant and/or the hindered amine light stabilizing compound comprises ≦25 weight % of the total resin solids of the amine component. In certain embodiments, the total amount of anti-oxidant and/or the hindered amine light stabilizing compound can range between any combination of values, which were recited in the preceding sentences, inclusive of the recited values. For example, in some embodiments, the total amount of anti-oxidant and/or hindered amine light stabilizing compound can range from 10 weight % to 20 weight %, such as from 10 weight % to 12 weight based on the total resin solids of the amine component.

In certain embodiments, the coating composition, after it has been cured, has a Shore D hardness of ≧1 as measured by ASTM-D240. In other embodiments, the coating composition, after it has been cured, has a Shore hardness of ≦75 as measured by ASTM-D240. In other embodiments, the Shore D hardness of the coating composition, after it has been cured, can range between any combination of values, which were recited in the preceding sentences, inclusive of the recited values. For example, in some embodiments, the Shore D hardness can be ≦65, such as from 5 to 65 or 10 to 50, as measured by ASTM-D240.

In some embodiments, the coating composition, after it has been cured, has a flex modulus of ≧1 mPa as measured by ASTM-412. In certain embodiments, the coating composition, after it has been cured, has a flex modulus ≦1500 mPa as measured by ASTM-412, such as ≦1500 mPa. In other embodiments, the flex modulus of the coating composition, after it has been cured, can range between any combination of values, which were recited in the preceding sentences, inclusive of the recited values. For example, in some embodiments, the flex modulus of the coating after it has been cured can range from 100 mPa to 300 mPa, such as from 140 mPa to 170 mPa, as measured by ASTM-412.

In certain embodiments, the coating composition, after it has been cured, has a % elongation of ≧10 as measured by ASTM-412.

The amine component may be referred to herein as a “curative” because it will react or cure with the isocyanate to form a polyurea. In certain embodiments, the ratio of equivalents of isocyanate groups to equivalents of amine groups is greater than 1 and the isocyanate component and the amine component can be applied to a substrate at a volume mixing ratio of 1:1.

### Isocyanate Component

As used herein, the term “isocyanate” includes unblocked compounds capable of forming a covalent bond with a reactive group such as a hydroxyl, thiol or amine functional group. Thus, isocyanate can refer to “free isocyanate”, which will be understood to those skilled in the art. In certain embodiments, the isocyanate of the present invention can be monofunctional (containing one isocyanate functional group (NCO)) or the isocyanate used in the present invention can be polyfunctional (containing two or more isocyanate functional groups (NCOs)).

Suitable isocyanates for use in the present invention are numerous and can vary widely. Such isocyanates can include those that are known in the art. Non-limiting examples of suitable isocyanates can include monomeric and/or polymeric isocyanates. The isocyanates can be selected from monomers, prepolymers, oligomers, or blends thereof. In an embodiment, the isocyanate can be C₂-C₂₀ linear, branched, cyclic, aromatic, or blends thereof.

Suitable isocyanates for use in the present invention may include but are not limited to isophorone diisocyanate (IPDI), which is 3,3,5-trimethyl-5-isocyanato-methyl-cyclohexyl isocyanate; hydrogenated materials such as cyclohexylene diisocyanate, 4,4′-methylenedicyclohexyl diisocyanate (H₁₂MDI); mixed aralkyl diisocyanates such as tetramethylxylyl diisocyanates, OCN—C(CH₃)₂—C₆H₄C(CH₃)₂—NCO; polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate; and mixtures thereof.

Non-limiting examples of aromatic isocyanates for use in the present invention may include but are not limited to phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate, alkylated benzene diisocyanates, methylene-interrupted aromatic diisocyanates such as methylenediphenyl diisocyanate, 4,4′-isomer (MDI) including alkylated analogs such as 3,3′-dimethyl-4,4′-diphenylmethane diisocyanate, polymeric methylenediphenyl diisocyanate; and mixtures thereof.

In certain embodiments, isocyanate monomer may be used. It is believed that the use of an isocyanate monomer (i.e., residual-free monomer from the preparation of prepolymer) may decrease the viscosity of the polyurea composition thereby improving its flowability, and may provide improved adhesion of the polyurea coating to a previously applied coating and/or to an uncoated substrate. In alternate embodiments of the present invention, at least 1 percent by weight, or at least 2 percent by weight, or at least 4 percent by weight of the isocyanate component comprises at least one isocyanate monomer.

In certain embodiments of the present invention, the isocyanate can include oligomeric isocyanate such as but not limited to dimers such as the uretdione of 1,6-hexamethylene diisocyanate, trimers such as the biuret and isocyanurate of 1,6-hexanediisocyanate and the isocyanurate of isophorone diisocyanate, allophonates and polymeric oligomers. Modified isocyanates can also be used, including but not limited to carbodiimides and uretone-imines, and mixtures thereof. Suitable materials include, without limitation, those available under the designation DESMODUR from Bayer Corporation of Pittsburgh, Pa. and include DESMODUR N 3200, DESMODUR N 3300, DESMODUR N 3400, DESMODUR XP 2410 and DESMODUR XP 2580.

In some embodiments, the isocyanate component comprises an isocyanate functional prepolymer formed from a reaction mixture comprising isocyanate and a material, such as a flame retardant material, comprising a phosphorus-containing polyol. In certain embodiments, the isocyanate component also comprises an isocyanate (non-prepolymer isocyanate or additional isocyanate) that is not used to form the isocyanate functional prepolymer. It should be noted that the non-prepolymer isocyanate can be the same or different from the isocyanate used to form the isocyanate functional prepolymer. It should also be noted that in certain embodiments, the isocyanate functional prepolymers can be substantially compatible with the non-prepolymer isocyanate. As used herein, “substantially compatible” means the ability of a material to form a blend with other materials that is and will remain substantially homogeneous over time.

As used herein, “prepolymer” means isocyanate that is pre-reacted with polyamine or other isocyanate reactive group such as polyol. As used herein, “isocyanate functional prepolymer” means prepolymer having at least one isocyanate functional group (NCO). As stated above, in certain embodiments of the present invention, an isocyanate functional prepolymer comprises isocyanate that is pre-reacted with a material comprising a phosphorus-containing polyol wherein the ratio of equivalents of isocyanate groups (NCOs) to equivalents of hydroxyl groups (OHs) is greater than 1. Suitable isocyanates include those previously disclosed herein. Any phosphorus-containing polyols known in the art can be used in the present invention. Suitable phosphorus-containing polyols include, but are not limited to, phosphate and polyphosphate polyols, phosphite and polyphosphite polyols, phosphonate, polyphosphonate polyols, or combinations thereof. In certain embodiments, the phosphorus-containing polyols are EXOLIT OP 550 (LV) (available from Clariant Corporation), LEVAGARD 4090N (available from Lanxess Corporation), and blends thereof. In certain embodiments, the phosphorus-containing polyols may comprise two or more hydroxyl groups.

In certain embodiments, the phosphorus-containing polyol can be the reaction product of an initial phosphorus-containing polyol with an epoxy functional compound. It will be recognized by those skilled in the art that the reaction product of a polyol with an epoxy functional compound will also be a polyol. The initial phosphorus-containing polyol can include those phosphorus-containing polyols known in the art, such as those described in the preceding paragraph. It should be noted that the phosphorus (i.e., inorganic) content of many polyols can render them or the reaction products comprising them substantially incompatible with organic materials, such as the non-prepolymer isocyanates, useful in the “first component” in this invention. As used herein, the term “substantially incompatible” means the inability of a material to form a blend with other materials. Accordingly, the blend will remain substantially heterogeneous over time. Increasing the organic content of the initial phosphorus polyol by modification with another compound, such as an epoxy functional compound, can improve the compatibility of the initial phosphorus polyol with organic materials, such as the non-prepolymer isocyanate, while maintaining the flame retardant properties of the initial phosphorus polyol. Any epoxy functional compounds known in the art may be utilized in the present invention. Suitable epoxy functional compounds include, without limitation, ethylene oxide, propylene oxide, 1,2-epoxybutane, butyl glycidyl ether, and CARDURA E-10P (neodecanoic acid glycidyl ester available from Resolution Performance Products LLC). In certain embodiments, the phosphorus-containing polyol comprises the reaction product of EXOLIT OP 550 (LV) and CARDURA E-10P.

In certain embodiments, the phosphorus-containing polyol can be the reaction product of a phosphorus-containing acid and an epoxy functional compound. Any phosphorus-containing acid known in the art can be used in the present invention. Suitable phosphorus-containing acids include, without limitation, phenyl phosphonic acid, methyl phosphonic acid, ethyl phosphonic acid, propyl phosphoric acid, butyl phosphonic acid, or combinations thereof. In certain embodiments, the phosphorus-containing acid comprises organic functionality, such as alkyl, aryl, alkylaryl groups, for reasons of compatibility with organic materials as described in the preceding paragraph. In certain embodiments, the phosphorus-containing acid comprises phenyl phosphonic acid, and the epoxy functional compound comprises propylene oxide. In certain embodiments, the phosphorus-containing acid comprises phenyl phosphonic acid and the epoxy comprises CARDURA E10-P.

In certain embodiments, the phosphorus-containing polyol can be the reaction product of a phosphorus-containing acid and an epoxy functional compound, and wherein the reaction is conducted in the presence of an initial phosphorus-containing polyol. In certain embodiments, the phosphorus-containing polyol can be the reaction product of a phosphorus-containing acid, an epoxy functional compound, and, optionally, an initial phosphorus-containing polyol. For example, in certain embodiments, the phosphorus-containing acid comprises phenyl phosphonic acid, the epoxy comprises propylene oxide, and the initial phosphorus-containing polyol comprises EXOLIT OP 550 (LV). In another particular embodiment, the phosphorus-containing acid comprises phenyl phosphonic acid, the epoxy comprises CARDURA E-10P, and the initial phosphorus-containing polyol comprises EXOLIT OP 550 (LV). Other examples of phosphorus-containing polyols that may be used in the present invention are described in U.S. patent application Ser. No. 12/122,980, which is incorporated in its entirety herein by reference.

The isocyanate functional prepolymer may further comprise an additional polyol, and/or polythiol, and/or polyamine. Suitable polyols are numerous and can vary widely. Such polyols can include those that are known in the art. Non-limiting examples of suitable polyols can include but are not limited to polyether polyols, polyester polyols, polyurea polyols (e.g., the Michael reaction product of an amino functional polyurea with a hydroxyl functional (meth)acrylate), polycaprolactone polyols, polycarbonate polyols, polyurethane polyols, poly vinyl alcohols, addition polymers of unsaturated monomers with pendant hydroxyl groups such as those containing hydroxy functional (meth)acrylates, allyl alcohols and mixtures thereof. Non-limiting examples can include but are not limited to diols such as 1,2-butane diol, glycols such as neopentyl glycol and mixtures thereof. Further examples include commercially available materials such as TERATHANE 650 from Invista Corporation. In certain embodiments, wherein the isocyanate functional prepolymer comprises an additional polyol, the ratio of equivalents of isocyanate groups (NCOs) to equivalents of hydroxyl groups (OHs) is greater than 1.

In some embodiments, however, the polyol used in the formation of the pre-polymer is not a phosphorus-containing polyol. Suitable non-phosphorous-containing polyols include polytetrahydrofuran materials such as those sold under the tradename TERATHANE (e.g., TERATHANE 250, TERATHANE 650, TERETHANE 1000 available from Invista Corporation).

A “polythiol” refers to such a compound having more than one SH group, such as a dithiol or higher functionality thiol. Suitable polythiols are numerous and can vary widely. Such polythiols can include those that are known in the art. Non-limiting examples of suitable polythiols can include, but not limited to, trimethylolpropane trimercaptoacetate, pentaerythritol tetramercaptoacetate, trimethylolpropane tris(β-thiopropionate) and pentaerythritol tetrakis (β-thiopropionate), thioplast G4 and G44 (available from Akzo Nobel), 3,6-dioxa-1,8-octanedithiol (available from Sigma-Aldrich), or mixtures thereof. In certain embodiments, wherein the isocyanate functional prepolymer comprises a polythiol, the ratio of equivalents of isocyanate groups (NCOs) to equivalents of thiol groups (SHs) is greater than 1.

### Amine Component

As stated above, the amine component comprises an amine compound such as a polyamine compound. Suitable polyamines are numerous and can vary widely. Such polyamines can include those that are known in the art. Non-limiting examples of suitable polyamines can include, but are not limited to, primary and secondary amines, and mixtures thereof, such as any of those listed herein. Amine terminated polyureas may also be used. Amines comprising tertiary amine functionality can be used provided that the amine further comprises at least two primary and/or secondary amino groups. In certain embodiments, wherein the isocyanate functional prepolymer comprises a polyamine, the ratio of equivalents of isocyanate groups (NCOs) to equivalents of amine groups (NHs) is greater than 1.

As noted above, the polyurea of the present compositions is formed from a reaction mixture comprising an isocyanate component and an amine component.

Suitable amines for use in the present invention are numerous and can vary widely. Such amines can include those that are known in the art such as primary and secondary amines, and mixtures thereof. In certain embodiments, the amine may include monoamines, or polyamines having at least two functional groups such as di-, tri-, or higher functional amines; and mixtures thereof. In further embodiments, the amine may be aromatic or aliphatic such as cycloaliphatic, or mixtures thereof. Non-limiting examples of suitable monoamines can include aliphatic polyamines such as, but not limited to, ethylamine, isomeric propylamines, butylamines, pentylamines, hexylamines, cyclohexylamine, and benzylamine. Suitable primary polyamines include, but are not limited to, ethylene diamine, 1,2-diaminopropane, 1,4-diaminobutane, 1,3-diaminopentane (DYTEK EP, Invista), 1,6-diaminohexane, 2-methyl-1,5-pentane diamine (DYTEK A, Invista), 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′-diaminodicyclohexyl methane, 4,4′-diaminodicyclohexyl methane (PACM-20, Air Products) and 3,3′-dialkyl-4,4′-diaminodicyclohexyl methanes (such as 3,3′-dimethyl-4,4′-diaminodicyclohexyl methane (DIMETHYL DICYKAN or LAROMIN C260, BASF; ANCAMINE 2049, Air Products) and 3,3′-diethyl-4,4′-diaminodicyclohexyl methane), 2,4- and/or 2,6-diaminotoluene, 3,5-diethyltoluene-2,4-diamine, 3,5-diethyltoluene-2,6-diamine, 3,5-dimethylthio-2,4-toluenediamine, 3,5-dimethylthio-2,4-toluenediamine, 2,4′- and/or 4,4′-diaminodiphenyl methane, dipropylene triamine, his hexamethylene triamine, or combinations thereof. Polyoxyalkyleneamines are also suitable. Polyoxyalkyleneamines comprise two of more primary or secondary amino groups attached to a backbone, derived, for example, from propylene oxide, ethylene oxide, butylene oxide or a mixture thereof. Examples of such amines include those available under the designation JEFFAMINE, such as, without limitation, JEFFAMINE D-230, D-400, D-2000, HK-511, ED-600, ED-900, ED-2003, T-403, T-3000, T-5000, SD-231, SD-401, SD-2001, and ST-404 (Huntsman Corporation). Such amines have an approximate molecular weight ranging from 200 to 7500.

Secondary cycloaliphatic diamines may also be used in the present invention. Suitable cycloaliphatic diamines include, without limitation, JEFFLINK 754 (Huntsman Corporation), CLEARLINK 1000 (Dorf-Ketal Chemicals, LLC), and aspartic ester functional amines, such as those available under the name DESMOPHEN such as DESMOPHEN NH1220, DESMOPHEN NH 1420, and DESMOPHEN NH 1520 (Bayer Materials Science LLC.). Other suitable secondary amines that can be used in the present invention include the reaction products of materials comprising primary amine functionality, such as those described herein, with acrylonitrile. For example, the secondary amine can be the reaction product of 4,4′-diaminodicyclohexylmethane and acrylonitrile. Alternatively, the secondary amine can be the reaction product of isophorone diamine and acrylonitrile, such as POLYCLEAR 136 (available from Hansen Group LLC). In certain embodiments, the aspartic ester functional amine can comprise ≧1 weight % of the second component based on the total resin solids of that component. In other embodiments, the aspartic ester functional amine can comprise ≦60 weight % of the second component based on the total resin solids of that component. In some embodiments, the amount of aspartic ester functional amine can range between any combination of values, which were recited in the preceding sentences, inclusive of the recited values. For example, in certain embodiments, the aspartic ester functional amine can comprise from 5 weight % to 35 weight % of the second component based on the total resin solids of the second component. In other embodiments,

Other amines that can be used in the present invention include adducts of primary polyamines with mono or polyepoxies such as the reaction product of isophorone diamine with CARDURA E-10P.

The present polyurea compositions may also comprise one or more amines such as those described in U.S. patent application Ser. Nos. 11/611,979, 11/611,984, 11/611,988, 11/611,982, and 11/611,986, all of which are incorporated in their entirety herein by reference.

In certain embodiments, the amine component may be a mixture of primary and secondary amines wherein the primary amine may be present in an amount of from 20 to 80 percent by weight or from 20 to 50 percent by weight, with the balance being secondary amine. In other embodiments, the primary amines present in the composition may have a molecular weight greater than 200, and the secondary amines present may include diamine having molecular weight of at least 190 or from 210 to 230.

In certain embodiments, the second component of the composition, and/or the composition itself, are substantially free of primary amine functionality (unreacted primary amino groups). “Substantially free of primary amine functionality” and like terms means that theoretically there is no primary amine functionality but there maybe some primary amine functionality present that is purely incidental, i.e., impurities in amines that are otherwise secondary amine functional and/or trace primary amine functionality that did not react.

In another embodiment, the amine component may include at least one secondary amine which may be present in an amount of from 20 to 80 percent by weight or 50 to 80 percent by weight.

In another embodiment, the amine component may include aliphatic amine. It is believed that the presence of aliphatic amine may provide enhanced durability. In this embodiment, the amine has a viscosity ranging from 100 mPas up to 3000 mPas at 25° C.

In certain embodiments, the amine component may further comprise hydroxyl containing materials such as glycerol, QADROL (available from BASF), amino alcohols, the polytetrahydrofuran materials listed above, or combinations thereof.

### Additional Materials

In certain embodiments, the coating composition may comprise an additional flame and/or a heat resistant material, such a flame retardant material(s), in addition to the isocyanate functional pre-polymer described herein. The additional flame retardant material can be added to the isocyanate and/or the amine component of the present invention. Any flame retardant material known in the art can be used as the additional flame retardant material in the present invention.

In certain embodiments, a flame retardant material comprising graphite can be added to the isocyanate and/or the amine component of the coating compositions of the present invention. Suitable graphites are known in the art and can include natural and synthetic graphites. Non-limiting examples of suitable graphites can include expandable graphite and/or exfoliated graphite. In certain embodiments, expandable graphite in the form of a solid or powder is intercalated with an acid such as, but not limited to, organic acids (e.g., acetic acid) and inorganic acids (e.g., H₂SO₄ and HNO₃). Non-limiting examples of such graphites include commercially available graphites under the tradenames NORD-MIN from Nano Technologies, Incorporated and NYAGRAPH including, but not limited to, NYAGRAPH 35, 251 and 351, from Nyacol, Incorporated. In certain embodiments, if the graphite is added to the first component, the graphite can be substantially compatible with the isocyanate functional prepolymers and the additional isocyanate.

Other suitable flame retardant materials include, without limitation, the flame retardant polymers disclosed in U.S. Pat. Nos. 6,015,510 (column 4, line 31 thru column 5, line 41) and 5,998,503 (column 4, line 31 thru column 5, line 41), halogenated phosphates or halogen free phosphates, powdered or fumed silica, layered silicates, aluminum hydroxide, brominated fire retardants, tris(2-chloropropyl) phosphate, tris(2,3-dibromopropyl)phosphate, tris(1,3-dichloropropyl)phosphate, diammonium phosphate, various halogenated aromatic compounds, antimony oxide, alumina trihydrate, polyvinyl chloride and the like, and mixtures thereof. In certain embodiments, the flame retardant material is tris(2-chloropropyl) phosphate, which is available from Supresta under the designation FYROL PCF. When the flame retardant is a low viscosity liquid, it also can reduce the viscosity of the isocyanate and/or amine component, enhancing sprayability.

In certain embodiments, the flame retardant material may include at least one phosphinic salt of the formula (I), and/or one diphosphinic salt of the formula (II), and/or polymers of these,

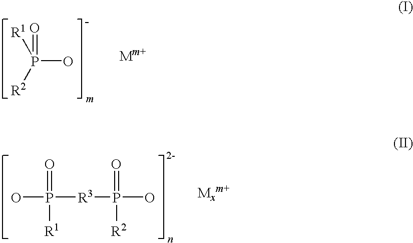

wherein R¹ and R² are identical or different and are C₁-C₆-alkyl, linear or branched, and/or aryl; R³ is C₁-C₁₀-alkylene, linear or branched, C₆-C₁₀-arylene, -alkylarylene, or -arylalkylene; M is Mg, Ca, Al, Sb, Sn, Ge, Ti, Zn, Fe, Zr, Ce, Bi, Sr, Mn, Li, Na, K and/or a protonated nitrogen base; m is from 1 to 4; n is from 1 to 4; x is from 1 to 4, and also may include at least one synergistic halogen-containing component. The flame retardant component of this embodiment is further described in U.S. Patent Publication Nos. 2005/0004277A1 and 2005/0004278A1, from paragraph [0025] to paragraph [0070] in both applications.

In certain embodiments, the additional flame retardant may optionally contain mineral oxides such as, but not limited to, zinc borate, barium metaborates, calcium borate, melamine and/or melamine derivatives such as, but not limited to, melamine cyanurate, melamine phosphates, polymelamine phosphates, melamine pyrophosphates, polymelamine pyrophosphates, melamine borate, other melamine derivatives and the like, and mixtures thereof.

The amount of the additional flame retardant material in addition to the isocyanate functional pre-polymer present in the coating composition of the present invention can vary widely. In certain embodiments, the additional flame retardant material and the isocyanate functional pre-polymer comprise up to 35 percent by weight based on the total weight of reactants in the coating composition.

In certain embodiments, the coating compositions used according to the present invention may include a blend of polyurea and polyurethane. As used herein, “polyurea” includes both polyurea and blends of polyurea and polyurethane. It will be appreciated by those skilled in the art that polyurethane can be formed as a by-product in the reactions according to the present invention. In alternate embodiments, the polyurethane can be formed in-situ and/or it can be added to the reaction mixture; a non-limiting example is an isocyanate functional prepolymer formed by the reaction of a polyol and an isocyanate as disclosed herein. A non-limiting example of polyurethane formed in-situ may include the reaction product of isocyanate and hydroxyl-functional material. Non-limiting examples of suitable isocyanates may include those described herein. Non-limiting examples of suitable hydroxyl-functional material may include polyols such as those described herein. Another example of polyurethane formed in-situ may include the reaction product of a hydroxyl functional prepolymer and isocyanate-functional material. Suitable examples of these reactants may include those described herein. The coating composition of the present invention may be formulated and applied using various techniques known in the art.

The polyurea coating compositions of the present invention may optionally include materials standard in the art such as but not limited to fillers, fiberglass, stabilizers, thickeners, adhesion promoters, catalysts, colorants, antioxidants, UV absorbers, hindered amine light stabilizers, rheology modifiers, flow additives, anti-static agents and other performance or property modifiers which are well known in the art of surface coatings, and mixtures thereof. Suitable rheology modifiers include solid and/or liquid rheology modifiers, which can be organic and/or inorganic based polymers, such as bentonite clay, fumed silica, BYK 411 (available from Chemie), or combinations thereof. In alternate embodiments, such materials may be combined with the isocyanate component, the amine component, or both. In a further embodiment, at least one of these materials is added to the amine prior to reaction with isocyanate.

In another embodiment, the composition further comprises a filler such as but not limited to clay, silica or mixtures thereof. In a further embodiment, the filler is added to the amine. Such a coating composition has been found to have better adhesion to a metal substrate than a similar coating composition without clay or silica (as determined in accordance with the test method in ASTM D 1876, without use of a fixturing device).

The clay may be selected from any of a variety of clays known in the art including montmorillonite clays such as bentonite, kaolin clays, attapulgite clays, sepiolite clay, and mixtures thereof. Additionally, the clay may be surface treated as is known in the art. Any suitable surface treatment may be used. In a non-limiting embodiment, the clay is treated with one or more of the following amines:

R¹—NR²R³

R¹—N⁺R²R³R⁷

R⁴—C(O)—NR⁵—R⁶—NR²R³

R⁴—C(O)—NR⁵—R⁶—N⁺R²R³R⁷

wherein R¹ and R⁴ are independently C₄-C₂₄ linear, branched, or cyclic alkyl, aryl, alkenyl, aralkyl or aralkyl, R², R³, R⁵ and R⁷ are independently H or C₁-C₂₀ linear, branched, or cyclic alkyl, aryl, alkenyl, aralkyl or aralkyl, and R⁶ is C₁-C₂₄ linear, branched, or cyclic alkylene, arylene, alkenylene, aralkylene or aralkylene.

In a non-limiting embodiment, surface treated bentonite as described in U.S. Pat. No. 3,974,125 may be used.

In an embodiment, the clay may be present in the coating composition of the present invention in an amount of at least 0.5 percent by weight, or at least 1 percent by weight, or at least 1.5 percent by weight. In other embodiments, the clay can be present in an amount of up to 6 percent by weight, or up to 5 percent by weight, or up to 4 percent by weight of the composition. The amount of clay in the coating composition can be any value or range between any values recited above, with the proviso that the adhesion properties and application viscosity of the coating composition are not adversely affected.

In another embodiment, the coating composition of the present invention may include silica. Any suitable silica can be used, provided that application and coating performance properties are not adversely impacted. The silica may be selected from surface-treated/surface-modified silica, untreated/unmodified silica and mixtures thereof. Non-limiting examples of suitable silica may include, but are not limited to, precipitated, fumed, colloidal, and mixtures thereof. In alternate non-limiting embodiments, the silica may be present in an amount such that it constitutes at least 0.5 percent by weight, or at least 1 percent by weight, or at least 1.5 percent by weight of the coating composition. In other embodiments, the silica can be present such that it constitutes up to 6 percent by weight, or up to 5 percent by weight, or up to 4 percent by weight of the composition. The amount of silica in the two-component coating composition can be any value or range between any values recited above, provided that the adhesion properties and application viscosity of the coating composition are not adversely affected.

In another embodiment, the coating composition of the present invention may include an adhesion promoter which may enhance adhesion of the coating composition to a substrate. When the coating composition of the present invention is applied over a first coating, an adhesion promoter may be present in the first coating composition, or it may be added to the isocyanate and/or amine of the second coating composition, or it may be applied as a separate layer directly to the substrate or first coating prior to application of the second coating thereto. When applied as a separate layer, the adhesion promoter may be applied using a variety of conventional techniques such as but not limited to wiping, dipping, roll coating, curtain coating, spraying or the like.

Non-limiting examples of suitable adhesion promoters for use in the present invention may include amine-functional materials such as 1,3,4,6,7,8-hexahydro-2H-pyrimido-(1,2-A)-pyrimidine, hydroxyethyl piperazine, N-aminoethyl piperizine, dimethylamine ethylether, tetramethyliminopropoylamine (commercially available as POLYCAT 15 from Air Products and Chemicals, Inc.), blocked amines such as an adduct of IPDI and dimethylamine, tertiary amines, such as 1,5-diazabicyclo[4.3.0]non-5-ene, 1,8-diazabicyclo[5.4.0]undec-7-ene, 1,4-diazabicyclo[2.2.2]octane, 1,5,7-triazabicyclo[4.4.0]dec-5-ene, and 7-methyl-1,5,7-triazabicyclo[4.4.0]dec-5-ene, amino silanes such as γ-aminopropyltriethoxysilane (commercially available as Silquest A1100 from Momentive Performance Materials, Inc.), melamine or amino melamine resin (e.g., Cymel 220 or Cymel 303, available from Cytec Industries Inc.), metal complexes including metal chelate complexes such as an aluminum chelate complex (e.g., K-KAT 5218 available from King Industries) or tin-containing compositions such as stannous octoate and organotin compounds such as dibutyltin dilaurate and dibutyltin diacetate, urethane acrylate compositions, salts such as chlorine phosphate, butadiene resins such as an epoxidized, hydroxyl terminated polybutadiene resin (e.g., POLY BD 605E available from Atofina Chemicals, Inc.), polyester polyols (e.g., CAPA 3091, a polyester triol available from Solvay America, Inc., and urethane acrylate compositions such as an aromatic urethane acrylate oligomer (e.g., CN999 available from Sartomer Company, Inc.); and mixtures thereof. For example, the adhesion promoter disclosed in U.S. patent application Ser. No. 11/591,312, which is incorporated in its entirety herein by reference, may be used in the present invention.

It is believed that the underlying mechanism which enhances adhesion may involve one or more phenomena such as, but not limited to, catalysis of a reaction between reactive groups on the substrate or previously applied coating (e.g., hydroxyl groups) and functional groups of the coating composition, reaction with the substrate or bonding with the substrate such as via hydrogen bonding, although the inventors do not wish to be bound by any mechanism.

In an embodiment, the adhesion promoter comprises at least one component selected from melamine, urethane acrylate, metal chelate complex, salt, tin-containing compound and polyhydric polymer.

In certain embodiments, the coating (i.e., reaction mixture) may further comprise small amounts of solvent and in certain embodiments the coating may be substantially solvent-free. “Substantially solvent-free” means that the coating may contain a small amount of solvent, such as 5%, 2%, 1% or less.

In other embodiments, the coating may comprise primarily of solvent. For example, in certain embodiments, the coating may contain ≧5%, such 10%, 20%, 50% or higher.

In another embodiment, the coating composition of the present invention may include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm Nanoparticles can be produced by milling stock organic or inorganic pigments with grinding media having a particle size of less than 0.5 mm Example nanoparticle dispersions and methods for making them are identified in U.S. Pat. No. 6,875,800, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which “composite microparticles”, which comprise a nanoparticle and a resin coating on the nanoparticle, is dispersed. Example dispersions of resin-coated nanoparticles and methods for making them are identified in U.S. patent application Ser. No. 10/876,031 filed Jun. 24, 2004, which is incorporated herein by reference, and U.S. Provisional Application No. 60/482,167 filed Jun. 24, 2003, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity, or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In an embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. patent application Ser. No. 10/892,919 filed Jul. 16, 2004 and incorporated herein by reference.

In general, the colorant can be present in the coating composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

In another embodiment, the coating composition of the present invention when applied to a substrate possesses color that matches the color of an associated substrate. As used herein and in the claims, the term “matches” or like terms when referring to color matching means that the color of the coating composition of the present invention substantially corresponds to a desired color or the color of an associated substrate. This can be visually observed or confirmed using spectroscopy equipment.

The coatings of the present invention may be part of a multi-layer coating composite comprising a substrate with various coating layers such as a pretreatment layer, electrocoat, primer, base coat, and clear coat. At least one of the base coat and clear coat may contain colorant and/or the clear coat may contain an adhesion promoter. It is believed that the addition of adhesion promoter to the clear coat may improve the adhesion between the clear coat and the coating composition applied thereover, although the inventors do not wish to be bound by any mechanism. In this embodiment, the coating composition of the present invention may be the reaction product of isocyanate and amine with a colorant additive. The coating composition of the present invention containing colorant may be applied to at least a portion of the article or structure. The color of the coated article or structure may match the color of an associated substrate. An “associated substrate” may refer to a substrate which comprises the article or structure but is not coated with the coating composition of the present invention; or a substrate which is attached, connected or in close proximity to the article or structure, but is not coated with the coating composition of the present invention.

Methods of Coating a Substrate and/or Coated Substrates

Accordingly, the present invention is further directed to methods for coating a substrate comprising applying to at least a portion of the substrate any of the coating compositions described herein. In an embodiment, conventional spraying techniques may be used. In this embodiment, the isocyanate and amine may be combined such that the ratio of equivalents of isocyanate groups to equivalents of amine groups is greater than 1 and the isocyanate and amine can be applied to a substrate at a volume mixing ratio of 1:1; and the reaction mixture may be applied to an uncoated or coated substrate to form a first coating on the uncoated substrate or a subsequent coating on the coated substrate. When determining the ratio of equivalents of isocyanate groups to equivalents of reactive amine groups, the total amine reactive groups are taken into consideration; that is the amine groups from any amine or amines used in the coating. It will be understood by those skilled in the art that hydroxyl and/or thiol groups may be included into the tally of total reactive amine groups when calculating the ratio of equivalents of isocyanate to the equivalents in the amine component. Those skilled in the art will also recognize that other mixing volume or weight ratios can be used while maintaining the net ratio of isocyanate functional groups to the sum of amine, hydroxyl, and/or thiol groups is greater than 1.

It will be appreciated that the present compositions are two component or “2K” compositions, wherein the isocyanate component and the amine component are kept separate until just prior to application. Such compositions will be understood as curing under ambient conditions, although a heated forced air or a heat cure can be applied to accelerate final cure or to enhance coating properties such as adhesion. In an embodiment, the sprayable coating composition may be prepared using a two-component mixing device. In this embodiment, isocyanate and amine are added to a high pressure impingement mixing device. The isocyanate is added to the “A-side” and amine is added to the “B-side”. The A- and B-side streams are impinged upon each other and immediately sprayed onto at least a portion of an uncoated or coated substrate. The isocyanate and the amine react to produce a coating composition which is cured upon application to the uncoated or coated substrate. The A- and/or B-side can also be heated prior to application, such as to a temperature of 140° F. Heating may promote a better viscosity match between the two components and thus better mixing, but is not necessary for the curing reaction to occur.

In certain embodiments, the volume mixing ratio of the isocyanate and amine may be such that the resulting isocyanate and amine reaction mixture can be applied to a substrate at a volume mixing ratio of 1:1. As used herein, “volume mixing ratio 1:1” means that the volume mixing ratio varies by up to 20% for each component, or up to 10% or up to 5%. In other embodiments, the volume mixing ratio can range from 3:1 to 1:3.

It is believed that the ratio of equivalents of isocyanate groups to amine groups may be selected to control the rate of cure of the coating composition of the present invention. It has been found that cure and adhesion advantages may result when the ratio of the equivalents of isocyanate groups to amine groups (also known as the reaction index) is greater than one, such as from 1.5:1 to 0.9:1 or from 1.3:1 to 1.05:1. It is understood by those skilled in the art when calculating reaction index, one may optionally include the sum of the amine, hydroxyl and thiol groups as part of “amine” in this calculation.

In a non-limiting embodiment, a commercially available mixing device available commercially under the designation GUSMER VR-H-3000 proportioner fitted with a GUSMER Model GX-7 spray gun may be used. In this device, pressurized streams of the A- and B-side components are delivered from two separate chambers, are impacted or impinged upon each other at high velocity, to mix the two components and form a coating composition, which may be applied to an uncoated or coated substrate using the spray gun. The mixing forces experienced by the component streams may depend upon the volume of each stream entering the mixing chamber per unit time and the pressure at which the component streams are delivered. A 1:1 volume ratio of the isocyanate and amine per unit time may equalize these forces.

Another suitable application device known in the industry includes a “static mix tube” applicator. In this device, the isocyanate and amine are each stored in a separate chamber. As pressure is applied, each of the components is brought into a mixing tube in a 1:1 ratio by volume. Mixing of the components is effected by way of a torturous or cork screw pathway within the tube. The exit end of the tube may have atomization capability useful in spray application of the reaction mixture. Alternatively, the fluid reaction mixture may be applied to a substrate as a bead. A static mix tube applicator is commercially available from Cammda Corporation or Plas-Pak Industries, Inc.

The coating composition of the present invention may be applied to a wide variety of substrates. Non-limiting examples of suitable substrates can include, but are not limited to, metal, natural and/or synthetic stone, ceramic, glass, brick, cement, concrete, cinderblock, wood and composites and laminates thereof; wallboard, drywall, sheetrock, cement board, plastic, paper, PVC, roofing materials such as shingles, roofing composites and laminates, and roofing drywall, Styrofoam, plastic composites, acrylic composites, ballistic composites, asphalt, fiberglass, soil, gravel, and the like. Metals can include but are not limited to aluminum, cold rolled steel, electrogalvanized steel, hot dipped galvanized steel, titanium, and alloys; plastics can include but are not limited to TPO, SMC, TPU, polypropylene, polycarbonate, polyethylene, and polyamides (Nylon). The substrates can be primed metal and/or plastic; that is, an organic or inorganic layer is applied thereto. Further, the coating composition of the present invention can be applied to said substrates to impart one or more of a wide variety of properties such as but not limited to corrosion resistance, abrasion resistance, impact damage, flame and/or heat resistance, chemical resistance, UV light resistance, structural integrity, ballistic mitigation, blast mitigation, sound dampening, decoration and the like. As used herein, “ballistic mitigation” refers to reducing or alleviating the effects of a bullet or other type of firearm ammunition. As used herein, “blast mitigation” refers to reducing or alleviating the secondary effects of a blast. In non-limiting examples, the coating composition of the present invention can be applied to at least a portion of a building structure or an article of manufacture such as but not limited to a vehicle. “Vehicle” includes, but is not limited to, civilian, commercial, and military land-, water-, and air-vehicles, for example, cars, trucks, boats, ships, submarines, airplanes, helicopters, humvees and tanks. The article of manufacture can be a building structure. “Building structure” includes, but is not limited, to at least a portion of a structure including residential, commercial and military structures, for example, roofs, floors, support beams, walls and the like. “Building structure” also includes structures, including those that define apertures, associated with mining. Typical mine structures include mains, submains, gate road entries, production panels, bleeders, and other active working areas associated with underground mining Accordingly, the present compositions can also be used to coat mine supports, beams, seals, stoppings, ribs, exposed strata, and the like and can be further used, alone or in conjunction with other layers, to seal and/or reinforce mine structures. As used herein, the term “substrate” may refer to a surface, either external or internal, on at least a portion of an article of manufacture or the article of manufacture itself. In an embodiment, the substrate is a truck bed.

In an embodiment, the coating composition of the present invention may be applied to a carrier film. The carrier film can be selected from a wide variety of such materials known in the art. Non-limiting examples of suitable carrier films may include, but are not limited to, thermoplastic materials, thermosetting materials, metal foils, cellulosic paper, synthetic papers, and mixtures thereof. As used herein, the term “thermoplastic material” refers to any material that is capable of softening or fusing when heated and of solidifying (hardening) again when cooled. Non-limiting examples of suitable thermoplastic materials may include polyolefins, polyurethanes, polyesters, polyamides, polyureas, acrylics, and mixtures thereof. As used herein, the term “thermosetting material” refers to any material that becomes permanently rigid after being heated and/or cured. Non-limiting examples may include polyurethane polymers, polyester polymers, polyamide polymers, polyurea polymers, polycarbonate polymers, acrylic polymers, resins, copolymers thereof, and mixtures thereof. As used herein, the term “foil” refers to a thin and flexible sheet of metal. Non-limiting examples may include aluminum, iron, copper, manganese, nickel, combinations thereof, and alloys thereof. As used herein, the term “synthetic paper” refers to synthetic plain or calendered sheets that can be coated or uncoated and are made from films containing polypropylene, polyethylene, polystyrene, cellulose esters, polyethylene terephthalate, polyethylene naphthalate, poly 1,4-cyclohexanedimethylene terephthalate, polyvinyl acetate, polyimide, polycarbonate, and combinations and mixtures thereof. A non-limiting example of suitable synthetic paper is available under the tradename TESLIN from PPG Industries, Inc., Pittsburgh, Pa.

In an embodiment, a carrier film having a first and second major surface may serve as a substrate and the coating composition of the present invention may be applied to the first surface of the film to form a coating layer.

In other embodiments, the carrier film may have a film thickness of at least 0.5 μm, or at least 1 μm, or at least 2 μm, or at least 3 μm or at least 5 μm. In other embodiments, the carrier film may have a thickness of up to 1 inch. The carrier film can vary and range between any thickness recited above provided that the carrier film can adequately support the coating layer and is sufficiently flexible for a desired end use application. In some embodiments, the flex modulus of the carrier film can be ≦1500 mPA, such as ≦1400 mPa, as measured by ASTM-412.

In another embodiment, the carrier film may include an adhesive layer superimposed on the second surface of the film. Any suitable adhesive composition known in the art can be used to form the adhesive layer. Suitable adhesive compositions include those that contain at least one acrylic latex polymer prepared from a monomer composition that includes C₁-C₅ linear, branched, or cyclic alkyl (meth)acrylate monomers.

In a further embodiment, a temporary protective cover may be superimposed over the adhesive layer. Any suitable material can be used as the protective cover. Suitable materials include, but are not limited to, paper and polymeric materials. In these embodiments, the temporary protective cover can be removed and the second side of the carrier film may be applied or adhered to a desired substrate.

In certain embodiments, the coating composition of the present invention may be applied to a bare (e.g., untreated, uncoated) substrate, a pretreated substrate and/or coated substrate having at least one other coating. In an embodiment, the coating composition of the present invention may be applied to a multi-layer coating composite. The first coating applied to a substrate may be selected from a variety of coating compositions known in the art for surface coating substrates. Non-limiting examples may include but are not limited to electrodepositable film-forming compositions, primer compositions, pigmented or non-pigmented monocoat compositions, pigmented or non-pigmented base coat compositions, transparent topcoat compositions, industrial coating compositions, and the like. In another non-limiting embodiment, the coating composition of the present invention may be applied to a multi-layer coating composite comprising a pretreated substrate and coating layers such as but not limited to electrocoat, primer, base coat, clear coat, and combinations thereof.

In another embodiment, the coating composition of the present invention can be used in a two-coat application resulting in a textured surface. A first coat is applied to an uncoated or coated substrate to produce a smooth, substantially tack-free layer. The Tack-Free Method is used to determine if the layer is substantially tack-free. The Tack-Free Method includes spraying the coating composition in one coat onto a non-adhering plastic sheet to a thickness of from 10 to 15 mil (254-381 microns). When spraying is complete, an operator, using a loose fitting, disposable vinyl glove, such as one commercially available under the trade name Ambidex Disposable Vinyl Glove by Marigold Industrial, Norcross Ga., gently touches the surface of the coating. The coating may be touched more than one time by using a different fingertip. When the glove tip no longer sticks to, or must be pulled from, the surface of the layer, the layer is said to be substantially tack-free. The time beginning from the completion of spraying until when the coating is substantially tack-free is said to be the tack-free time. In an embodiment, the tack-free time and the cure time may be controlled by balancing levels of various composition components such as the ratio of primary amine to secondary amine.

A second coat may then be applied to the first coating layer as a texturizing layer or “dust coating”. The second coating layer can be applied by increasing the distance between the application/mixing device and the coated substrate to form discrete droplets of the coating composition prior to contacting the coated substrate thereby forming controlled non-uniformity in the surface of the second layer. The substantially tack-free first layer of the coating is at least partially resistant to the second layer; i.e., at least partially resistant to coalescence of the droplets of coating composition sprayed thereon as the second layer or dust coating such that the droplets adhere to but do not coalesce with the previous layer(s) to create surface texture. The final coating layer typically exhibits more surface texture than the first or previous coating layers. An overall thickness of the coating layers may range from 20 to 1000 mils, or from 40 to 150 mils, or from 60 to 100 mils (1524-2540 microns), or from 500 to 750 mils In a non-limiting embodiment, the first layer may be the majority of the total thickness and the dust coating may be from 15-50 mils (381-1270 microns). In various embodiments of the present invention, the “first” coating layer may comprise one, two, three or more layers; and the “second” coating layer may be one or more subsequent layers applied thereover. For example, four polyurea layers may be applied, with the fourth layer being the dust coating and each layer having a thickness of from 15 to 25 mil (381-635 microns). It will be appreciated that these coating layers are relatively “thick”. The coating compositions of the present invention can also be applied as much thinner layers as well, such as 0.1 to less than 15 mils, such as 0.1 to 10, 0.5 to 3, or 1 to 2 mils Any of the endpoints within these ranges can also be combined. Such layers can be used alone or in conjunction with other coating layers, such as any of those known in the art or otherwise described herein. When applied at a sufficient thickness (e.g., 10 to 1000 mils, such as 100 to 200 mils, or 125 mils+/−10 mils), the present polyurea layer(s) can provide blast and/or ballistic mitigation.

In other embodiments, the coating layers may comprise the same or different polyurea or polyurea/polyurethane coating compositions. For example, the first layer may be a polyurea composition comprising aliphatic, and/or aromatic amine components, and/or aliphatic, and/or aromatic isocyanate; and the second layer may comprise the same or different combination of aliphatic and/or aromatic amine components and/or aliphatic and/or aromatic isocyanate. “Amine component” in this context means any amine used in the present coatings. In another embodiment, the outermost coating layer may comprise a coating composition that provides a desired durability. The desired durability may depend upon the use of the coating composition of the present invention and/or the substrate to which it may be applied. In an embodiment, a combination of aliphatic and/or aromatic amine and/or isocyanate may be selected such that the composition of the outermost layer has substantial durability. For example, the outermost coating layer may have a durability of from 1000 kJ to 6000 kJ, or from 800 hours to 4000 hours, when tested using a Weatherometer (Atlas Material Testing Solutions) in accordance with method SAE J1960. In this embodiment, the first layer may be a polyurea composition comprising isocyanate and amine, wherein at least one of the amine and/or polyisocyante may be aromatic, and the second layer may be a polyurea composition comprising aliphatic amine and aliphatic isocyanate.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### EXAMPLES

### Example 1

A phosphonic acid ester diol was prepared from the following ingredients:

| | | Weight % based |
|---|---|---|
| Charge | Material | on total solids |
| 1 | Phenyl phosphonic acid | 26.81 |
| | FYROL PCF¹ | 40.73 |
| 2 | Propylene oxide | 19.69 |
| 3 | Propylene oxide | 9.84 |
| 4 | Propylene oxide | 1.64 |
| 5 | Propylene oxide | 1.24 |

¹Chlorophosphate ester-fire retardant available from Supresta

Charge 1 was added to a suitable flask equipped with a thermocouple, N₂ inlet, addition funnel, and overhead stirrer. The material was placed under an N₂ blanket and heated to 51° C. Charge 2 was added over 3.5 hours, at a temperature of 51-52° C. The reaction mixture and FYROL PCF was initially a slurry, but went into solution and cleared up within the first two hours of the feed. One hour after the completion of Charge 2, the acid value of the reaction mixture was found to be 46.3 mg KOH/g. Charge 3 was then added over 1.5 hours at a temperature of 52° C. and held one hour; the acid value of the reaction mixture was 8.4 mg KOH/g. Charge 4 was then added at 50° C. over 15 minutes and held 1 hour; the acid value of the reaction mixture was then determined to be 6.1 mg KOH/g. Charge 5 was then added over 15 minutes and held 1 hour; the acid value of the reaction mixture was 3.9 mg KOH/g, and the epoxy equivalent weight was 4613. Vacuum was applied to the reaction mixture at 60 mm Hg for 1.8 hours at a temperature of 50° C. to remove residual propylene oxide from the reaction mixture. The final product was a clear liquid with a measured solids (110° C., 1 hr) of 65.3%, a Gardner-Holt bubble tube viscosity of G+, an acid value of 3.0 mg KOH/g, a hydroxyl value of 185.2, an epoxy equivalent weight of >100000, and a weight average molecular weight of 314 and a number average molecular weight of 240 as determined by gel permeation chromatography versus a polystyrene standard.

### Example 2

One embodiment of the isocyanate component and the amine component of the present invention were prepared in the following manner:

### Side A

### Isocyanate Side/Component

| | | Weight % based |
|---|---|---|
| Charge | Material | on total solids |
| 1 | Isophorone di-isocyanate¹ | 18.41 |
| 2 | Phenylphosphonic acid/ | 15.06 |
| | propylene oxide² | |
| 3 | Dibutyltin dilaurate catalyst | 0.003 |
| 4 | FYROL PCF³ | 10.04 |
| 5 | DESMODUR XP 2580⁴ | 36.72 |
| 6 | DESMODUR XP 2410⁵ | 19.77 |

¹Available from Degussa
²Prepared as described in Example G of U.S. Patent Application No. 12/122,980 or WO Patent Pub. No. 2009/142,999
³Chlorophosphate ester-fire retardant available from Supresta
⁴Available from Bayer
⁵Available from Bayer

Charge 1 was added to a reaction vessel which was placed under a nitrogen blanket. Charges 2 and 3 were then added to the reaction vessel and the mixture was stirred for 15 minutes. The mixture was then heated to 50° C. and held at that temperature for 20 minutes. After 20 minutes, the temperature was raised to 60° C. and held at that temperature for another 20 minutes. The temperature of the mixture was increased in 10° C. intervals until 80° C. was reached. Each time the temperature was increased, that particular temperature was held for 20 minutes. After the mixture was heated at 80° C. for 20 minutes, the mixture was slowly heated to 100° C. The mixture was held at 100° C. until an isocyanate equivalent weight of 388 g/eqv. or greater was reached. Once the target isocyanate equivalent weight was reached, the mixture was cooled to 80° C. and Charge 4 was added to the reaction vessel while the mixture was being stirred. Charges 5 and 6 were then added and the mixture was stirred for 1 hour. Additional amounts of Charges 5 and 6 were added to reach a target isocyanate equivalent weight of 268 g/eqv.

### Side B

### Amine Side/Component

### Grind Paste:

| | | Weight % based |
|---|---|---|
| Charge | Material | on total solids |
| 1 | JEFFAMINE T3000¹ | 24.6 |
| 2 | JEFFLINK 745² | 26.5 |
| 3 | DESMOPHEN NH 1220³ | 26.1 |
| 4 | VULCAN XC72 BEAD FORM⁴ | 1.2 |
| 5 | BENTONE 34⁵ | 1.0 |
| 6 | BYK-9077⁶ | 0.6 |
| 7 | ANOX IC-14⁷ | 10 |

¹Available from Huntsman International
²Available from Huntsman International
³Aspartic ester amine reactant available from Bayer
⁴Available from Cabot
⁵Available from Akzo Chemical
⁶Available from BYK-Chemie
⁷Phenolic based anti-oxidant available from Chemtura

A pre-mix was formed by adding Charges 1-3 to a vessel, then adding Charges 4-7 to the vessel under agitation. Agitation was produced using a high shear cowls blade. The pre-mix was agitated for 1 hour before being milled/ground to approximately 7.5 Hegman using an Eiger Mill (Model MK-11), which was filled with 210 ml of grind media (Zircoa PLUS-TZP Mill Mates 1.0 mm) thereby forming a grind paste.

| | | Weight % based |
|---|---|---|
| Charge | Material | on total solids |
| 1 | Grind Paste | 73.5 |
| 2 | JEFFLINK 754¹ | 76.5 |
| 3 | EVERSORB 93² | 8 |
| 4 | FYROL PCF³ | 8 |

¹Available from Huntsman
²Available from Everlight Chemical Industrial Corp.
³Chlorophosphate ester-fire retardant available from Supresta

Charges 1-4 were then blended to form an amine component.

### Example 3

Another embodiment of the isocyanate component and the amine component of the present invention were prepared in the following manner:

### Side A

### Isocyanate Side/Component

| | | Weight % based |
|---|---|---|
| Charge | Material | on total solids |
| 1 | Isophorone di-isocyanate¹ | 19.79 |
| 2 | Phosphonic acid ester diol of | 25.1 |
| | Example 1 | |
| 3 | Dibutyltin dilaurate catalyst | 0.003 |
| 4 | DESMODUR XP 2580² | 35.82 |
| 5 | DESMODUR XP 2410³ | 19.29 |

¹Available from Degussa
²Available from Bayer
³Available from Bayer

Charge 1 was added to a reaction vessel which was placed under a nitrogen blanket. Charges 2 and 3 were then added to the reaction vessel and the mixture was stirred for 15 minutes. The mixture was then heated to 50° C. and held at that temperature for 20 minutes. After 20 minutes, the temperature was raised to 60° C. and held at that temperature for another 20 minutes. The temperature of the mixture was increased in 10° C. intervals until 80° C. was reached. Each time the temperature was increased, that particular temperature was held for 20 minutes. After the mixture was heated at 80° C. for 20 minutes, the mixture was slowly heated to 100° C. The mixture was held at 100° C. until an isocyanate equivalent weight of 485 g/eqv. or greater was reached. Once the target isocyanate equivalent weight was reached, the mixture was cooled to 80° C. and Charges 4 and 5 were added to the reaction vessel while the mixture was stirred. The mixture was stirred for 1 hour at 80° C. and additional amounts of Charges 4 and 5 were added to reach a target isocyanate equivalent weight ranging from 268 to 274 g/eqv.

### Side B

### Amine Side/Component

### Grind Paste:

| | | Weight % based |
|---|---|---|
| Charge | Material | on total solids |
| 1 | JEFFAMINE T3000¹ | 16.8 |
| 2 | JEFFLINK 745² | 25.05 |
| 3 | DESMOPHEN NH 1220³ | 19 |
| 4 | VULCAN XC72 BEAD FORM⁴ | 1.2 |
| 5 | BENTONE 34⁵ | 2 |
| 6 | BYK-9077⁶ | 0.6 |
| 7 | ANOX IC-14⁷ | 10 |

¹Available from Huntsman International
²Available from Huntsman International
³Aspartic ester amine reactant available from Bayer
⁴Available from Cabot
⁵Available from Akzo Chemical
⁶Available from BYK-Chemie
⁷Phenolic based anti-oxidant available from Chemtura

A pre-mix was formed by adding Charges 1-3 to a vessel, then adding Charges 4-7 to the vessel under agitation. Agitation was produced using a high shear cowls blade. The pre-mix was agitated for 1 hour before being milled/ground to approximately 7.5 Hegman using an Eiger Mill (Model MK-11), which was filled with 210 ml of grind media (Zircoa PLUS-TZP Mill Mates 1.0 mm) thereby forming a grind paste.

| | | Weight % based |
|---|---|---|
| Charge | Material | on total solids |
| 1 | Grind Paste | 74.65 |
| 2 | JEFFAMINE T3000¹ | 2.2 |
| 3 | JEFFLINK 754² | 3.15 |
| 4 | DESMOPHEN NH 1220³ | 10 |
| 5 | EVERSORB 93⁴ | 2 |
| 6 | FYROL PCF⁵ | 8 |

¹Available from Huntsman International
²Available from Huntsman International
³Aspartic ester amine reactant available from Bayer
⁴Monomeric HALS available from Everlight Chemical Industrial Corp.
⁵Chlorophosphate ester-fire retardant available from Supresta

Charges 1-6 were then blended to form an amine component.

### Example 4

Yet another embodiment of the isocyanate component and the amine component of the present invention were prepared in the following manner:

### Side A

### Isocyanate Side/Component

| | | Weight % based |
|---|---|---|
| Charge | Material | on total solids |
| 1 | Isophorone di-isocyanate¹ | 19.79 |
| 2 | Phosphonic acid ester diol of | 25.1 |
| | Example 1 | |
| 3 | Dibutyltin dilaurate catalyst | 0.003 |
| 4 | DESMODUR XP 2580² | 35.82 |
| 5 | DESMODUR XP 2410³ | 19.29 |

¹Available from Degussa
²Available from Bayer
³Available from Bayer

Charge 1 was added to a reaction vessel which was placed under a nitrogen blanket. Charges 2 and 3 were then added to the reaction vessel and the mixture was stirred for 15 minutes. The mixture was then heated to 50° C. and held at that temperature for 20 minutes. After 20 minutes, the temperature was raised to 60° C. and held at that temperature for another 20 minutes. The temperature of the mixture was increased in 10° C. intervals until 80° C. was reached. Each time the temperature was increased, that particular temperature was held for 20 minutes. After the mixture was heated at 80° C. for 20 minutes, the mixture was slowly heated to 100° C. The mixture was held at 100° C. until an isocyanate equivalent weight of 485 g/eqv. or greater was reached. Once the target isocyanate equivalent weight was reached, the mixture was cooled to 80° C. and Charges 4 and 5 were added to the reaction vessel while the mixture was stirred. The mixture was stirred for 1 hour at 80° C. and additional amounts of Charges 4 and 5 were added to reach a target isocyanate equivalent weight ranging from 268 to 274 g/eqv.

### Side B

### Amine Side/Component

### Grind Paste:

| | | Weight % based |
|---|---|---|
| Charge | Material | on total solids |
| 1 | JEFFAMINE T3000¹ | 16.75 |
| 2 | JEFFLINK 745² | 28.45 |
| 3 | DESMOPHEN NH 1220³ | 16 |
| 4 | VULCAN XC72 BEAD FORM⁴ | 1.2 |
| 5 | BENTONE 34⁵ | 2 |
| 6 | BYK-9077⁶ | 0.6 |
| 7 | CHIMASORB 944⁷ | 2.0 |
| 8 | ANOX IC-14⁸ | 10 |

¹Available from Huntsman International
²Available from Huntsman International
³Aspartic ester amine reactant available from Bayer
⁴Available from Cabot
⁵Available from Akzo Chemical
⁶Available from BYK-Chemie
⁷Polymeric HALS available from Ciba
⁸Phenolic based anti-oxidant available from Chemtura

A pre-mix was formed by adding Charges 1-3 to a vessel, then adding Charges 4-8 to the vessel under agitation. Agitation was produced using a high shear cowls blade. The pre-mix was agitated for 1 hour before being milled/ground to approximately 7.5 Hegman using an Eiger Mill (Model MK-11), which was filled with 210 ml of grind media (Zircoa PLUS-TZP Mill Mates 1.0 mm) thereby forming a grind paste.

| | | Weight % based |
|---|---|---|
| Charge | Material | on total solids |
| 1 | Grind Paste | 77 |
| 2 | DESMOPHEN NH 1220¹ | 13 |
| 3 | EVERSORB 93² | 2 |
| 4 | FYROL PCF³ | 8 |

¹Aspartic ester amine reactant available from Bayer
²Monomeric HALS available from Everlight Chemical Industrial Corp.
³Chlorophosphate ester-fire retardant available from Supresta

Charges 1-4 were then blended to form an amine component.

### Physical Characteristics

Examples 2-3 were poured into a mold that was approximately ½ inch wide and 200 mil thick and allowed to cure. After cure, the samples were cut to a length of 6 inches prior to being tested pursuant to UL-94 standards. The non-certified data recorded from these tests are depicted in Table 1 below. In Table 1, the numeric values represent the amount time (seconds) it took before the flame on the sample was extinguished.

TABLE 1

| | Trial 1- First | Trial 1- Second | Trial 2- First | Trial 2- Second |
|---|---|---|---|---|
| | Burn Time | Burn Time | Burn Time | Burn Time |
| Example 2 | 20 | 4 | 20 | 4 |
| Example 3 | 1 | 24 | 11 | 16 |
| Example 4 | 16 | 1 | 1 | 4 |

The data shown above shows that all of the coatings, Examples 2-4, should achieve a V0 rating under the UL-94 standard.

Therefore, what is claimed is:

1. A coating composition comprising polyurea formed from a reaction mixture comprising: (a) a first component comprising isocyanate and (b) a second component comprising an amine; and wherein the reaction mixture further comprises an anti-oxidant compound, hindered amine light stabilizing compound, or combinations thereof; and wherein the anti-oxidant compound, hindered amine light stabilizing compound, or combinations thereof comprises 1 weight % to 20 weight % of the total resin solids of the coating composition.

2. The coating composition according to claim 1, wherein the second component comprises <40 weight % of an amine-functional aspartic acid ester based on total resin solids of the second component.

3. The coating composition according to claim 1, wherein the anti-oxidant comprises a phenolic based anti-oxidant, a phosphorus based anti-oxidant, or combinations thereof.

4. The coating composition according to claim 1, wherein the hindered amine light stabilizing compound comprises a polymeric hindered amine light stabilizing compound or a polymer comprising hindered amine light stabilizing functionality.

5. The coating composition according to claim 1, wherein the coating composition further comprises a flame retardant material that is different from the anti-oxidant compound and/or the hindered amine light stabilizing compound.

6. The coating composition according to claim 1, wherein the isocyanate in the first component comprises an isocyanate functional prepolymer formed from a reaction mixture comprising an isocyanate and a material comprising a phosphorus-containing polyol.

7. The coating composition according to claim 6, wherein the phosphorus-containing polyol is the reaction product of an initial phosphorus-containing polyol and an epoxy functional compound.

8. The coating composition according to claim 7, wherein the epoxy functional compound comprises ethylene oxide, propylene oxide, 1,2-epoxybutane, butyl glycidyl ether, neodecanoic acid glycidyl ester, or combinations thereof.

9. The coating composition according to claim 6, wherein the phosphorus-containing polyol is the reaction product of a phosphorus-containing acid, an epoxy functional compound, and, optionally, an initial phosphorus-containing polyol.

10. The coating composition according to claim 1, wherein at least 1 weight % of the first component comprises at least one polyisocyanate monomer based on total resin solids of the first component.

11. The coating composition according to claim 1, wherein the reaction mixture further comprises a clay and, optionally, a silica.

12. A coating composition comprising polyurea formed from a reaction mixture comprising: (a) a first component comprising isocyanate, wherein the first component comprises an isocyanate functional prepolymer formed from a reaction mixture comprising an isocyanate and a material comprising a phosphorus-containing polyol; (b) a second component comprising an amine; and wherein the reaction mixture further comprises an anti-oxidant compound, a hindered amine light stabilizing compound, or combinations thereof.

13. The coating composition according to claim 12, wherein the second component comprises <40 weight % of an amine-functional aspartic acid ester based on total resin solids of the second component.

14. The coating composition according to claim 12, wherein the anti-oxidant comprises a phenolic based anti-oxidant, a phosphorus based anti-oxidant, or combinations thereof.

15. The coating composition according to claim 12, wherein the hindered amine light stabilizing compound comprises a polymeric hindered amine light stabilizing compound or a polymer comprising hindered amine light stabilizing functionality.

16. The coating composition according to claim 12, wherein the anti-oxidant compound, hindered amine light stabilizing compound, or combinations thereof comprises 1 weight % to 20 weight % of the total resin solids of the coating composition.

17. The coating composition according to claim 12, wherein the phosphorus-containing polyol is the reaction product of an initial phosphorus-containing polyol and an epoxy functional compound.

18. The coating composition according to claim 17, wherein the epoxy functional compound comprises ethylene oxide, propylene oxide, 1,2-epoxybutane, butyl glycidyl ether, neodecanoic acid glycidyl ester, or combinations thereof.

19. The coating composition according to claim 12, wherein the phosphorus-containing polyol is the reaction product of a phosphorus-containing acid, an epoxy functional compound, and, optionally, an initial phosphorus-containing polyol material.

20. The coating composition according to claim 12, wherein at least 1 weight % of the first component comprises at least one polyisocyanate monomer based on the total resin solids of the first component.

21. The coating composition according to claim 12, wherein the reaction mixture further comprises a clay and, optionally, a silica.

22. A coated article comprising: a substrate; and a coating layer formed by the coating composition of claim 1 deposited on at least a portion of the substrate.
